(19) United States
(12) Patent Application Publication
(10) Pub. No.: US 2006/0046229 A1
(43) Pub. Date: Mar. 2, 2006

(54) Dental implant

(76) Inventor: Thomas J. Teich, Santa Ana, CA (US)

Correspondence Address: C. ROBERT VON HELLENS;CAHILL, VON HELLENS & GLAZER P.L.C., 155 PARK ONE,, 2141 E. HIGHLAND AVENUE, PHOENIX, AZ, 85016, US

(21) Appl. No.: 11/210,382

(22) Filed: Aug. 24, 2005

Related U.S. Application Data
(60) Provisional application No. 60/604,817, filed on Aug. 26, 2004.

(51) Int. Cl. A61C 8/00

(52) U.S. Cl. 433/173; 433/174

(57) ABSTRACT

A dental implant includes a spiral thread for threaded engagement with a passageway formed in bone or tooth to mechanically secure the implant. A hollow stem extends upwardly to provide a passageway to a plurality of outlets at the lower end to fill a mold from the bottom up to develop an abutment ultimately supporting a crown, bridgework, or other prosthetic. The stem includes an end for engagement by a conventional dental hand piece to rotatably insert the implant. The base of the stem may include a hexagonal nut or a double disc for engagement by a dental ratchet for final seating of the implant. The post of the implant may include one or more longitudinally aligned tips that can be cut off to conform the length of the post with the depth of bone or tooth into which it will become inserted. The stem may include one or more longitudinally aligned segments that may be severed to conform the length of the stem with the height of the crown, bridgework or prosthetic. In a variant implant, the post includes a further passageway extending from the passageway in the stem to permit injection of bonding material into the further passageway for discharge through outlets of the further passageway into annular grooves formed in the one about the cavity into which the post is inserted.

### CROSS REFERENCE TO RELATED APPLICATIONS

The present application is related to and claims priority of a provisional application entitled “Dental Implant”, filed Aug. 26, 2005, and assigned Ser. No. 60/604,817, by the present inventor.

### BACKGROUND OF THE INVENTION

1. Field of the Invention

The present invention relates to dental implants and, more particularly, to implants having a passageway and ports for injecting a curable composite material into a removable mold to form an abutment to support a crown, bridgework, or other prosthetic.

2. Description of Related Prior Art

Dental implants have been used for decades as part of a dental restoration process to provide anchors for crowns, bridgework and other prosthetics. Numerous embodiments of such implants and attendant mechanisms have been developed with greater or lesser degrees of success. Currently, the industry standard requires a dentist to have titanium parts produced by a manufacturer of the implants. The choice of such parts is a function of the proper angulations and shape of the abutments that are needed to produce ideal final restorations. Because of the numerous variables, a dentist must have in stock a large amount of abutment parts of various configurations so as to be immediately available when implant surgeries are underway. The time to evaluate current inventory, to create an order of needed inventory, to actually reorder inventory and to receive and restock new inventory requires significant staff time and overhead expenses.

For the past twenty or more years of implant designs, attempts have been made to develop a system that guarantees a fail safe method to secure an endosseus implant structure with a selected abutment. Numerous techniques and designs have been developed to approach this goal. The systems include Morse tapers, small internal screws, small internal secondary screws that serve to secure the main screw, internal hexagonal nuts, external hexagonal nuts or a combination of these. The potential for failure always exists even if to a small degree with the best and most elaborate designs. The ramifications for one connection failure in a full arch restoration involving numerous implants and multiple units of fixed bridgework splinted together can be very disastrous. That is, one broken screw can render the implant useless and potentially result in the failure of the entire restoration case. This may require removal of existing restorations and may require reconstruction of an entirely new restoration. Additionally, if a small screw loosens to the degree that it dislodges from the restoration, the danger of aspiration exists. A small screw aspirated into the lung of the patient could be potentially life threatening. Even the most minimal degree of treatment requires an office appointment to tighten a screw or to restore a connection. Additional appointments result in lost time for the patient and additional expense for the dentist as significant fees for such services cannot be charged. Accordingly, the concern to the patient that the restoration may be defective or that a similar situation may recur at the same site or at a different site in the mouth is a valid issue for the patient.

Even the best systems and designs in the industry have not totally eliminated the possibility of a disconnection issue. This problem has been addressed many times with many different implant and abutment interface connection structures, designs and methodologies. Nevertheless, the constant threat of an abutment fixture becoming loosened, rotating or becoming dislodged from the implant during extensive function of the restoration and throughout the life of the restoration still exists.

Presently available implant structures and methodologies still introduces the risk of not being able to complete a restoration in a single appointment due to inventory deficiencies. Such situation is very disturbing to both the patient and the dentist. Moreover, there exists a potential for the entire restoration procedure to be stopped and not completed. Such disruption requires additional appointments, anesthesia, cleansing of instruments, sterilization procedures, and normal set up and clean up. The lack of inventory may even lead to a patient having to be without teeth for a time period necessary to acquire missing stock. A solution is, of course, that of maintaining a significant inventory but an inventory of such size requires a significant financial investment that is not desired and may not even be feasible.

The potential for misplacement of any of this multitude of parts is always present. Moreover, removing a part from inventory and inserting it into the mouth only to discover that it is the wrong size or configuration sometimes occurs. If so, the part must be re-sterilized and re-labeled before subsequent use. A situation then exists of the possibility of incomplete or inadequate sterilization as well as improper labeling. The numerous small parts presently required creates the potential for loss or inadvertent discard. One solution to the retrieval of the wrong size or improper part is that of throwing it away. Such discard necessarily increases the costs. Many manufacturers also void any warranty with respect to any part that is re-sterilized and therefore dictates that such part be thrown away. A possibility exists to return a part to a manufacturer for replacement. This solution is seldom viable as it requires re-sterilizing the part, re-packaging the part, preparing the part to be shipped to the manufacturer for exchange and the need to receive a return authorization number from the manufacturer. The clerical time required may not be acceptable due to the attendant costs. Furthermore, such return and exchange will require a period of time that may not be acceptable and upon receipt, re-stocking and entry into inventory will further exacerbate the related clerical expenses.

### SUMMARY OF THE INVENTION

A one piece dental implant incorporates a spiral thread on the post for threaded engagement with bone. A stem extending from the post is hollow and includes one or more outlet ports at the base thereof proximate the post. The top of the stem is engageable by a conventional dental hand piece to screw the post into place. A dental ratchet engages the base of the stem to provide final tightening. A lip in an upper radially expanded area of the post supports a removable mold. A curable composite material is injected through the passageway of the stem and expelled through the ports to fill the mold. Upon curing, the mold is removed and the cured composite material is formed into the shape of the abutment desired. The post may include one or more longitudinally aligned removable tips to permit adjustment of the length of the post commensurate with the bone or tooth. Similarly, the stem may be cut commensurate with the height of the abutment to be formed. A more simple implant includes a post extending from a stem that supports a plurality of spaced apart discs. A removable mold may be placed about the stem and filled with composite material that can be shaped to form an abutment. Alternatively, a crown may include a cavity for receiving the stem with the cavity being filled with composite material to attach the crown to the stem. Another embodiment includes a stem having a bulbous end for insertion into a cavity in a crown. The cavity is filled with composite material to secure the crown to the stem. An intermediate step of using a mold to form an abutment about the stem prior to attachment of the crown can also be done. For a denture or the like a metal housing secured to a crown or other prosthetic can be snap fit with an O-ring disposed between the bulbous end and the top of the post.

It is therefore a primary object of the present invention to provide a one piece dental implant for supporting an abutment to be formed of composite material.

Another object of the present invention is to provide a one piece dental implant having a post modifiable in length to conform with the bone.

Yet another object of the present invention is to provide a dental implant having a stem modifiable in length to conform with the restoration to be supported.

Still another object of the present invention is to provide the stem of a one piece dental implant engageable with a conventional dental hand piece to rotate the implant into threaded engagement with bone.

A further object of the present invention is to provide a one piece dental implant having a stem engageable with a conventional dental ratchet to seat the implant.

A yet further object of the present invention is to provide a mold detachably attachable to a dental implant to form a configurable abutment of composite material to support a restoration.

A yet further object of the present invention is to provide a dental implant having a plurality of discs about the stem above the post for supporting an abutment of curable composite material.

A still further object of the present invention is to provide an implant having a stem with a bulbous end to serve as an anchor for an abutment of composite material.

A yet further object of the present invention is to provide an implant having a stem with a bulbous end to serve as an anchor for a metal clasp supporting a restoration.

A still further object of the present invention is to provide a method for implanting a dental implant and attaching a restoration thereto during a single procedure.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 is an isometric view of a dental implant;

FIG. 2 illustrates a conventional dental hand piece used to rotate the dental implant;

FIG. 3 is a cross sectional view of a first variant dental implant illustrating the passageways formed therein and in the implant shown in FIG. 1;

FIG. 4 illustrates the first variant dental implant;

FIG. 5a illustrates three embodiments of the first variant dental implant having different length posts;

FIG. 5b illustrates three embodiments of the first variant dental implant having different length stems;

FIG. 6 illustrates a conventional dental hand piece useable with the first variant dental implant;

FIG. 7 illustrates the configuration of the stem to accommodate different lengths while retaining the capability for engagement with a conventional dental hand piece FIG. 8 illustrates the use of a standard dental ratchet to seat the first variant dental implant;

FIG. 9a illustrates the dental implant with a mold temporarily attached thereto;

FIG. 9b illustrates the mold;

FIG. 10 illustrates a method of filling the mold with composite material about the stem of the implant;

FIG. 11a illustrates a dental implant having a skewed mold temporarily attached thereto;

FIG. 11b illustrates the skewed mold;

FIG. 12 illustrates a variant mold useable with a dental implant;

FIG. 13a illustrates a cross section of the variant mold attached to a dental implant;

FIG. 13b illustrates a partial cross section taken in FIG. 13a as shown by line 13b;

FIG. 13c illustrates a cross section of the variant mold attached to a dental implant and the flow of composite material therewithin;

FIG. 13d illustrates shaping of the cured composite material to form an abutment;

FIG. 14 illustrates a second variant of the dental implant extending from bone;

FIG. 15 illustrates the second variant dental implant implanted within the root canal of a tooth or bone and the abutment formed thereon;

FIG. 16 illustrates a third variant of the dental implant shown in FIG. 14 mounted within a channel in a tooth root or in bone and methodology related thereto;

FIG. 17 illustrates a fourth variant of the dental implant and the formation of composite material into an abutment;

FIG. 18 illustrates further details of the methodology for forming an abutment supported by the fourth variant; and

FIG. 19 illustrates a denture and the fourth variant dental implant after attachment of a crown.

### DESCRIPTION OF THE PREFERRED EMBODIMENT

FIG. 1 illustrates a dental implant 10 having a post 12 supporting a stem 14. The post includes a spiral thread 16 for threaded engagement with a pre-drilled cavity or channel in bone or a tooth. Section 18 of the post extending upwardly from spiral thread 16 is radially expanded, which expansion may be geometric, as illustrated, or a straight taper. Such expansion will insure a tight fit with the cavity drilled in the bone or tooth. A lip 20 is disposed at the upper end of section 18, the function of which will be described in greater detail below. Stem 14 is hollow and defines a passageway 22 disposed therewithin. The lower end of the stem includes a hexagonal nut 24 having six facets 26. Each of these facets may include an outlet port 28 in fluid communication with passageway 22 within stem 14. Upper end 30 of the stem includes a flat 32 configured to mechanically engage with the jaws of a conventional dental hand piece; thereby, the hand piece can impart rotation to the implant upon insertion into the cavity in bone or tooth. Nut 24 is configured and sized to mate with a conventional dental ratchet to accommodate final seating of the implant. A plurality of barbs, scored or roughened surface, or annular protrusions 34 are spaced along stem 14 to mechanically lock with the composite material to be formed about the stem. Although the term composite material is used herein, this term also encompasses adhesives, cement and other bonding materials customarily used in a dental office. It is to be understood that a section of stem 14 may be severed by conventional means to conform with the height of the abutment to be formed upon the stem.

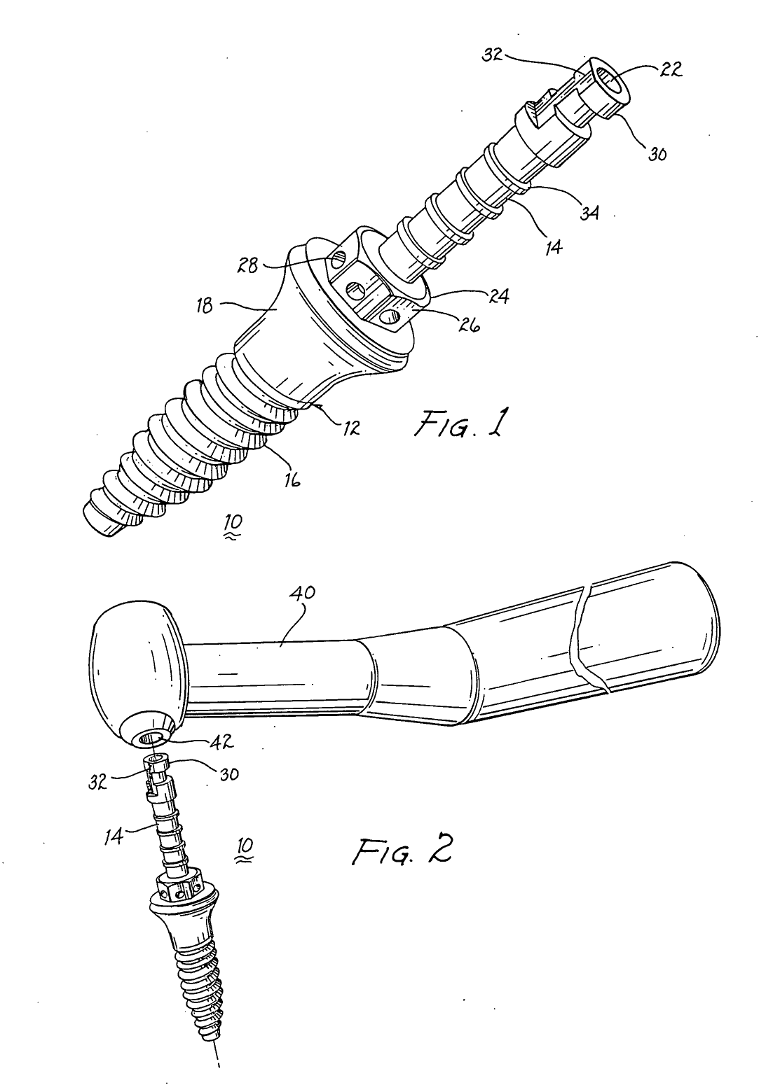

As particularly shown in FIG. 2, a representative dental hand piece 40 with a latch mechanism includes a conventional rotatable jaw 42 for engaging upper end 30 of implant 10. Flat 32 is engaged by jaw 42 to prevent independent rotation between stem 14 and jaw 42.

Referring to FIG. 3, there is shown a first variant 50 of dental implant 10. This variant is shown in cross section primarily to illustrate passageway 22 within variant stem 52. It is to be understood that this passageway is commensurate with the same passageway in implant 10. Furthermore, one of ports 28 is illustrated as being in fluid communication with passageway 22. Further passageways 54, 56 interconnect ports 28a and 28b with passageway 22. A pair of square discs 58, 60 extend from stem 52 at its base. Post 62 includes a spiral thread 64 like that shown for implant 10. The lower end of this post includes one or more longitudinally aligned tips 66, 68, each of which includes a spiral thread 70, 72, respectively.

As the depth to which post 64 may be inserted may vary as a function of the bone or the tooth into which it is to be inserted, one or both of tips 66, 68 may be severed prior to insertion to accommodate different judgments a dentist may make with respect to the depth of bone or tooth available and considerations of robustness necessary to support the dental prosthetic to be attached to the implant. Similarly, stem 52 may include several flats disposed therealong to permit severing an upper section of the stem and yet provide for engagement of the jaw of the dental hand piece with the remaining upper end of the stem. For example, flats 74, 76 and 78 may be incorporated. The final height of the stem would be a function of the height of the abutment to be formed about the stem. Thus, the stem may be cut close to the upper end of flat 76 or close to the upper end of flat 78. To facilitate such cutting, the wall thickness of the stem may be reduced, as depicted by notches 80, 82.

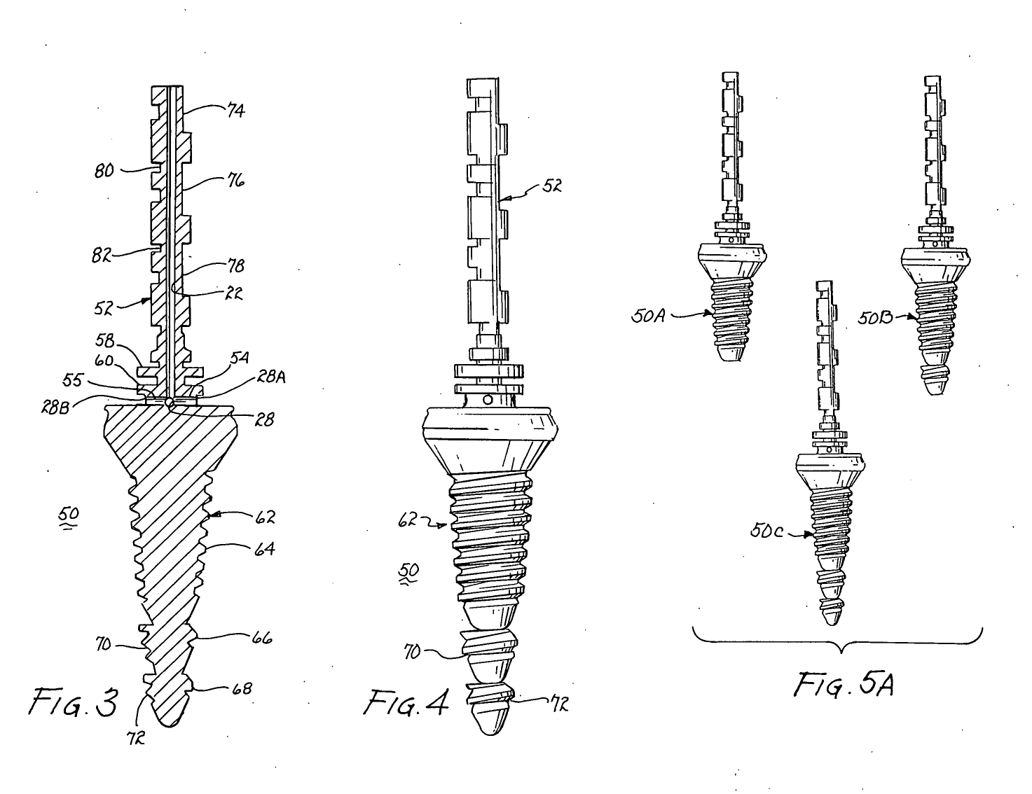

Referring to FIG. 4, various representative dimensions are illustrated. Post 62 of first variant 50 and without tips 70, 72 may be on the order of 9 millimeters (9 mm). Post 62 with tip 70 may be on the order of 12 millimeters (12 mm). Post 62 with tip 70 and 72 may be on the order of 15 millimeters (15 mm). The diameter of the post at its widest part may be in the range of about four to about eight millimeters (4-8 mm). With these dimensions, essentially all sites wherein the present invention is to be used, would be accommodated by no more than three implants of the type identified as first variant 50 irrespective of the diameter. As particularly depicted in FIG. 5a, first variant 50 may be configured as a small implant 50a, a medium sized implant 50b or a large sized implant 50c. As further shown in FIG. 5b, for an abutment of low height, stem 52 may be cut to its shortest length, as depicted by variant 50d. For a medium height abutment, the upper end of stem 52 may be cut, as depicted by variant 50e. For a full height abutment, the full length of stem 52 may be used, as depicted by variant 50f. For each of variants 50d, 50e, 50f, the respective posts are shown full length. However, it is to be understood that these posts may be shortened, as depicted in FIG. 5a.

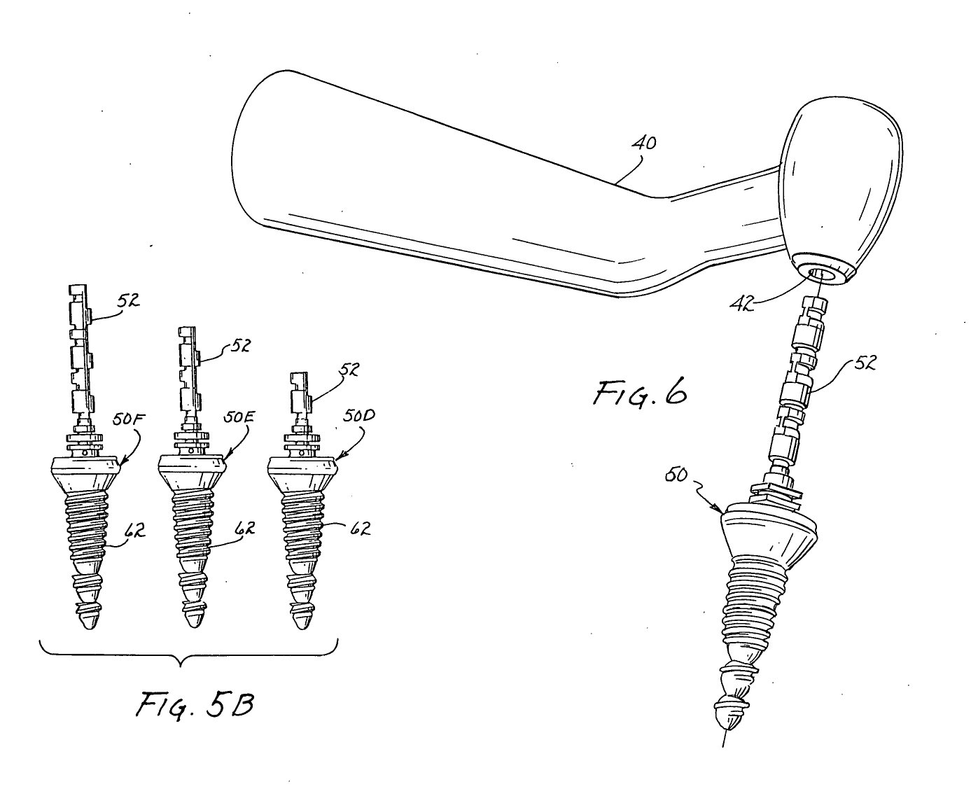

FIG. 6 illustrates a conventional dental hand piece 40 having a jaw 42 for engagement with the upper end of stem 52 of variant 50. If the stem is cut to a medium or small size, as depicted in FIG. 5b, the respective flats would be exposed for engagement by jaw 42, as described with respect to FIG. 3.

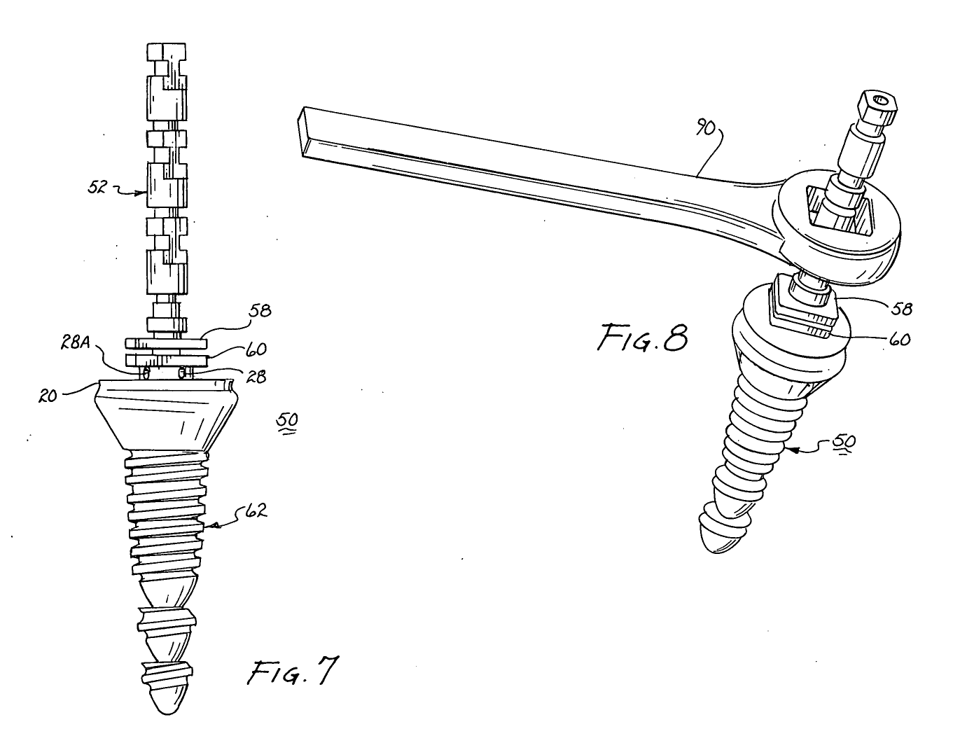

FIG. 7 is a side view of first variant 50 illustrating certain features not previously described. A lip 20 is formed therein to receive and temporarily retain a mold to define the abutment to be formed of composite material about stem 52. Discs 58, 60 are spaced apart from one another to permit a flow of the composite material therebetween and effect a strong grip about the stem. Ports, of which ports 28, 28a are shown, are in fluid communication with passageway 22 (see FIG. 3) extending through stem 52. These ports accommodate ejection of the composite material at the bottom of the mold (to be attached) to assist in evacuating all of the air within the mold and minimize the likelihood of air bubbles therein that might compromise the strength of the abutment to be formed.

FIG. 8 primarily illustrates a conventional dental ratchet for engaging discs 58, 60. This ratchet may be used by the dentist to firmly seat first variant 50 in bone or tooth, as the case may be.

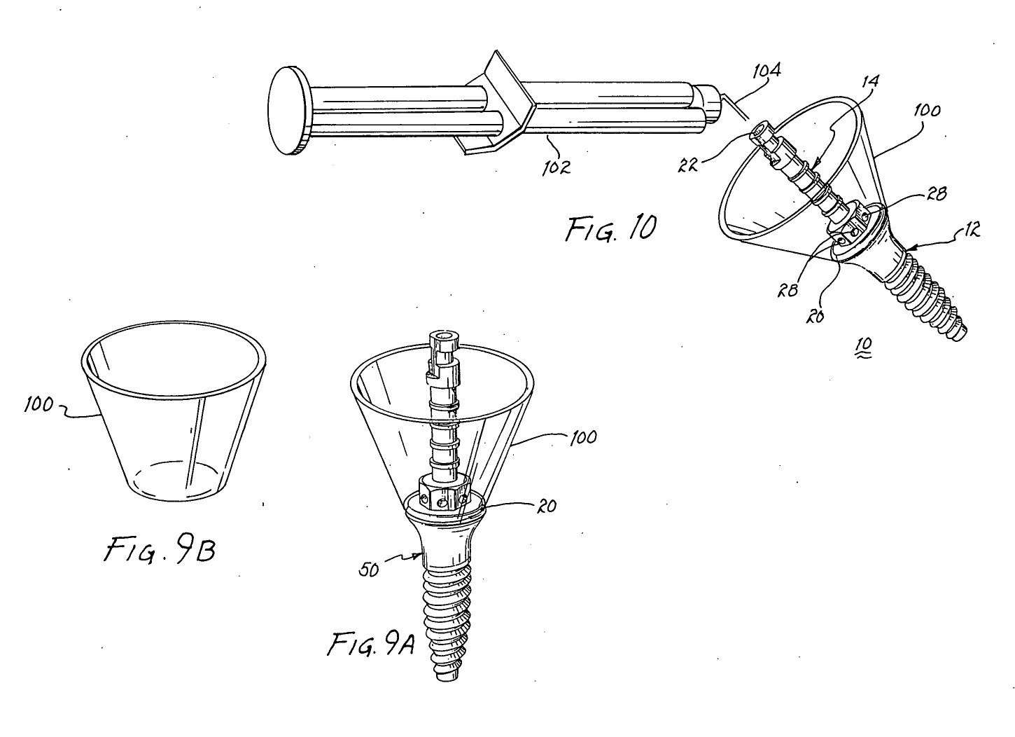

As illustrated in FIGS. 9a and 9b, a mold 100 in the form of an inverted truncated hollow cone engages lip 20 in a snap fit. Thereby, it is easily attached. After the composite material has filled the mold to the level determined appropriate by the dentist, the mold may be split and easily removed. It is to be understood that mold 100 is similarly attached to first variant 50.

FIG. 10 illustrates implant 10 with mold 100 attached to lip 20 through a snap fit. A conventional two part syringe 102 mixes two components to form a composite material that will cure through chemical reaction. The mixed composite material is ejected through a cannula 104 into passageway 22 extending through stem 14. The composite material is discharged through ports 28 and will fill mold 100 to a level to be determined by the dentist. After the composite material has cured, usually within a matter of minutes, the mold may be split and removed. Thereafter, the cured composite material may be formed to an appropriate configuration to receive and support a crown or other restoration to be mounted upon the implant. While implant 10 is illustrated, it is to be understood that the same procedure would be carried out with first variant 50.

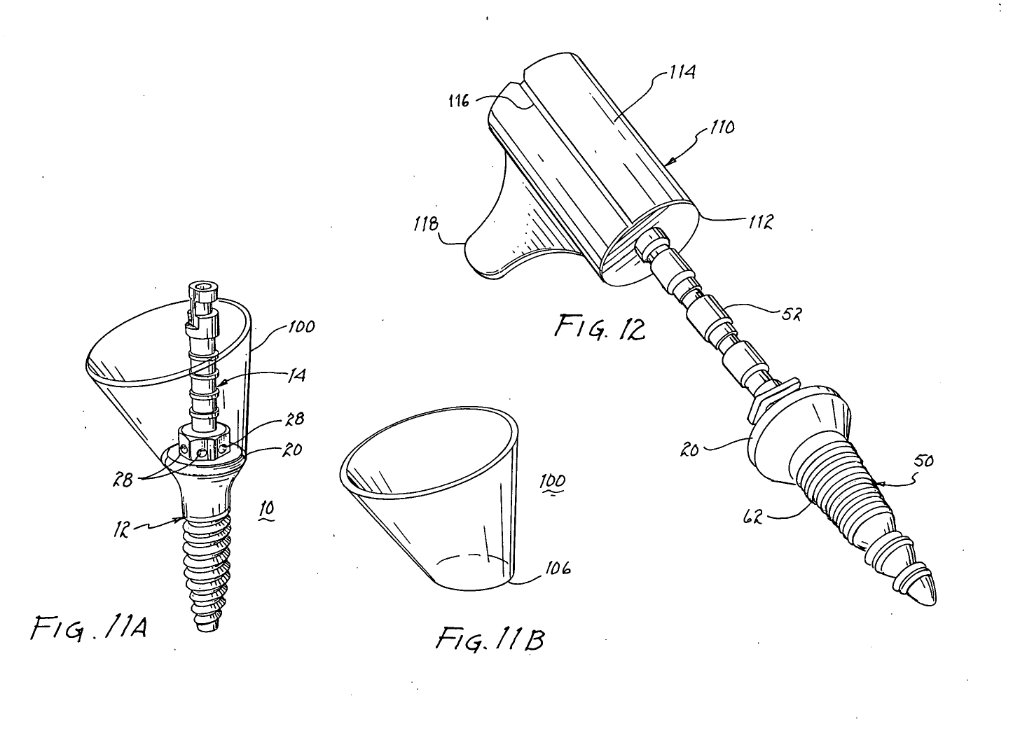

FIGS. 11a and 11b illustrate dental implant 10 with mold 100 being attached thereto through a snap fit, as described in further detail with respect to FIG. 10. For certain restorations, an implant cannot be positioned vertically as a function of the underlying bone or tooth. Therefore, it may have to be inserted at an angle off vertical. To permit the crown or other restoration to be attached to the implant in a normal orientation, a mold 100 having a skewed bottom perimeter 106 may be used. As particularly illustrated in FIG. 11a, the mold would not be in alignment with stem 14 but would be biased to the side as a function of the degree of skewing of perimeter 106. The abutment formed by such a mold can be shaped by the dentist to permit attachment of a crown or other restoration with a normal and expected positional orientation.

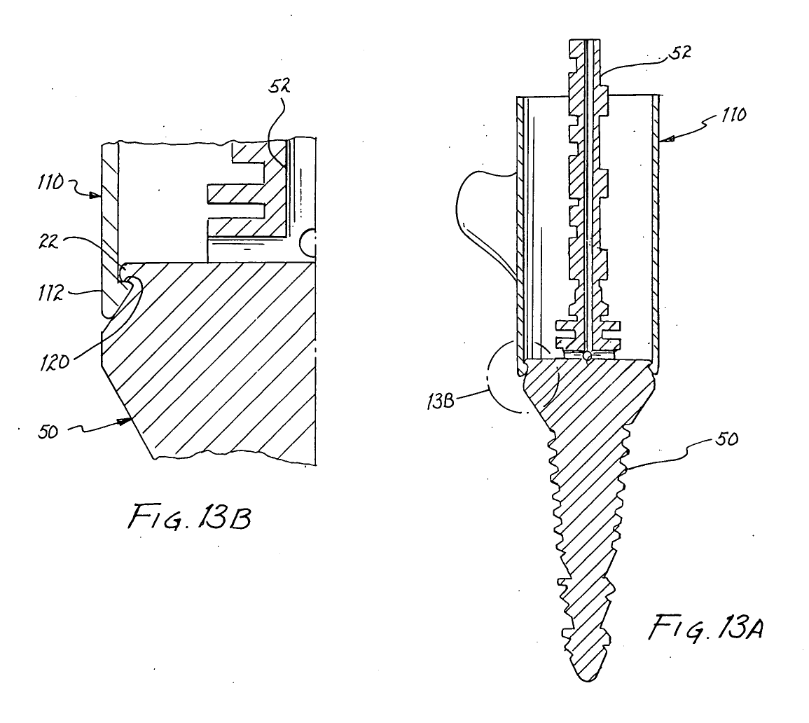

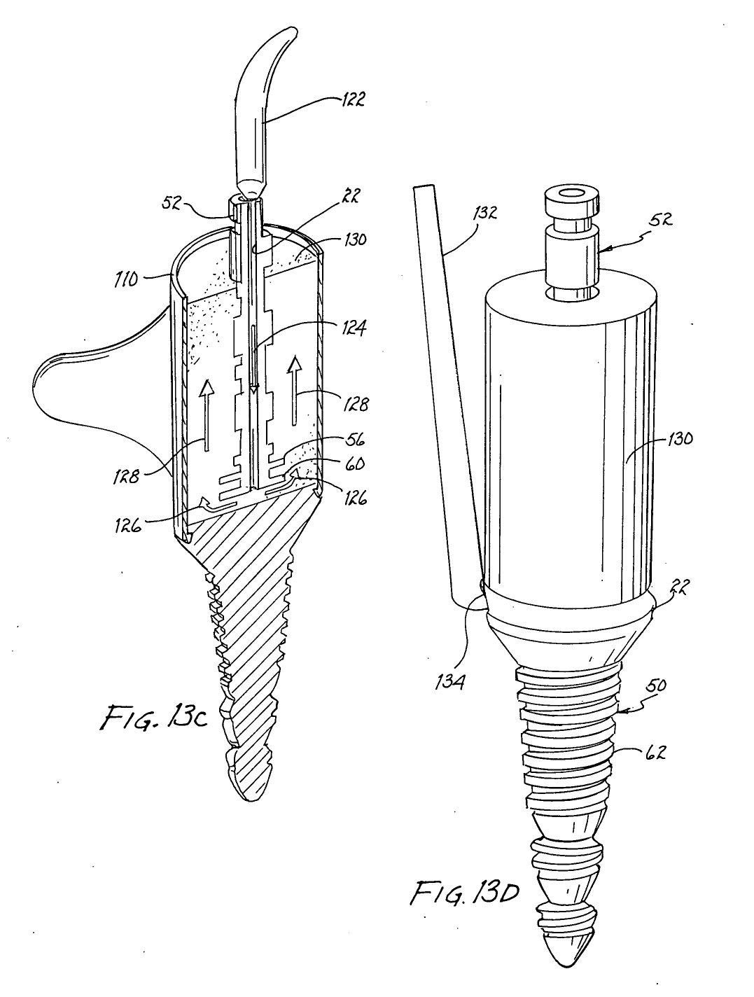

Referring jointly to FIGS. 12, 13a, 13b and 13c, a further mold 110 will be described. This mold is useable in conjunction with either first variant 50, as illustrated, or with implant 10 as discussed above. The mold is in the form of a cylinder having a lower circumferential edge 112 configured to mate with lip 20 and engage same in the manner of a snap fit. Cylinder 114, defining the mold, includes a rip slit 116. A tab 118 extends from the cylinder to facilitate manipulation of the mold into engagement with lip 20 of the implant, whether implant 10 or first variant 50.

As particularly shown in FIGS. 12, 13a and 13b, edge 112 of cylinder 114 includes an undercut 120 for snap fit engagement with lip 20. After mold 110 has been mounted, a curable hardenable composite material is ejected from a conduit 122, which may be equivalent to the cannula 104 of syringe 102 shown in FIG. 10. The composite material flows downwardly through passageway 22 of stem 52 as depicted by arrow 124. At the bottom of the passageway, the composite material is discharged laterally through each of ports 28, as depicted by arrows 126. As the composite material begins to fill mold 110, as depicted by arrows 128, it will envelope stem 52, including flow intermediate discs 58, 60. When a sufficient amount of composite material has flowed into the mold, further injection through passageway 22 is terminated. After the composite material has cured, mold 110 is removed by tearing it along rip slit 116 or a score line (see FIG. 12). Thereafter, it may be unwrapped from about the cured composite material, identified by reference numeral 130.

As shown in FIG. 13d, the cured composite material is in the shape of a cylinder abutting post 62 and enveloping more or less of stem 52. The composite material may be formed into an abutment with a shaping tool 132 to acquire the shape of the abutment for supporting the crown or other restoration intended to be mounted upon implant 10 or first variant implant 50. The shaping tool may include a knob 134, or similar element, for engaging lip 20 as a guide for the shaping tool. That is, by engaging knob 134 with the lip and canting the shaping tool toward cured composite material 130 and moving it circumferentially around the composite material, the composite material can be shaped into the form of a truncated cone with a reasonable degree of accuracy. To assist in this process, mold 110 may be in the form of a truncated cone instead of a cylinder.

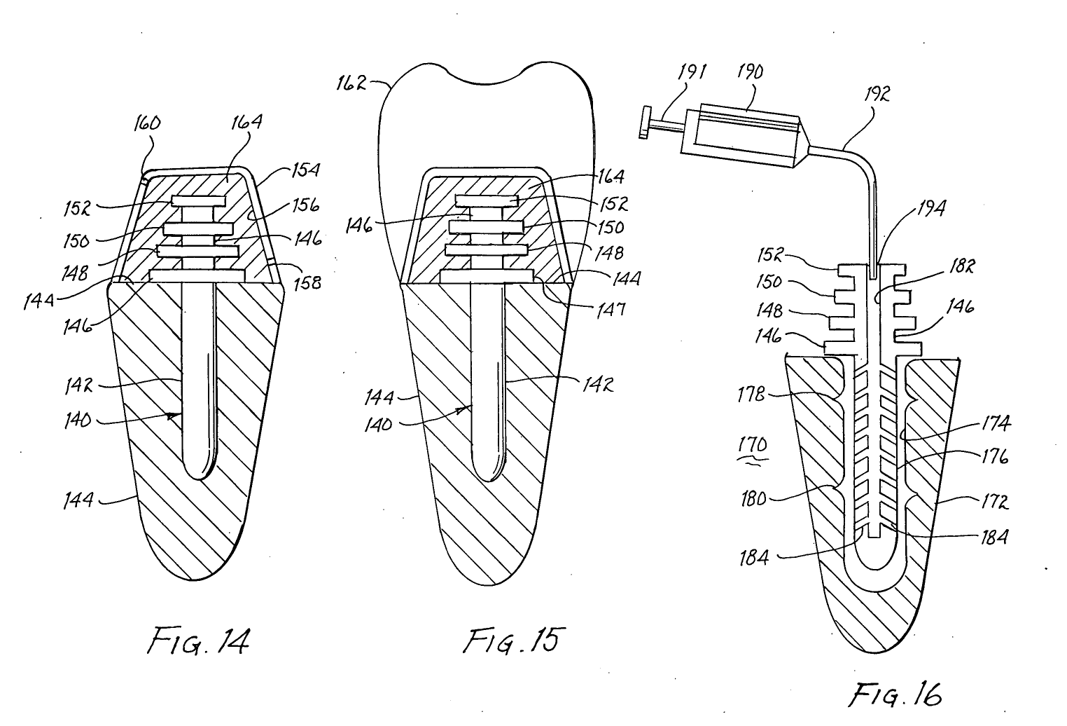

FIG. 14 illustrates a second variant implant 140. This implant includes a post 142 threadedly or otherwise mounted within bone or tooth 144. Stem 146, extending upwardly from the post, includes a plurality of spaced apart reduced diameter discs 147, 148, 150 and 152. As illustrated, lowermost disc 147 may rest upon bone or tooth 144. A mold 154 includes an interior cavity 156 that defines the shape of the abutment to be attached to stem 146. This mold is place upon bone or tooth 144, as illustrated. The mold includes an inlet port 158 and a vent 160. After placement of mold 154 upon bone or tooth 144, a syringe, or the like, containing the curable composite material (which may be a two part composition which cures shortly after mixing of the two parts) and includes a cannula or tube for insertion through inlet port 158. The composite material is injected into cavity 156 and will flow about the stem and its supported discs until the material reaches vent 160 whereafter the excess composite material is expelled. After curing, mold 154 is removed to leave an abutment enveloping and mechanically attached to stem 146 and its discs. The shape of this abutment conforms with the crown or other restoration to be attached or may be further shaped to support the crown or other restoration. A crown 162 is attached to abutment 164, as shown in FIG. 15.

By using mold 154, the clean up work by a dentist using existing procedures for attaching a crown are avoided. That is, present procedures include filling the cavity in crown with composite material; slathering composite material on the protruding stem of the implant; forcing the crown onto the implant; and removing the composite material that oozes out between the margin of the crown and the gum tissue. Usually, the gum tissue is injured and the patient will suffer discomfort, if not pain.

FIG. 16 illustrates a third variant implant 170, which is another version of second variant implant 140, illustrated in FIGS. 14 and 15. Bone or tooth 172 is drilled to provide a passageway 174 for receiving post 176. Additionally, one or more annular grooves 178, 180 are formed within passageway 174. The third variant implant includes a stem 146 and a plurality of discs, 147, 148, 150, 152 (like second variant implant 140). A passageway 182 extends through stem 146 and post 176. Additionally, a plurality of lateral passageways collectively identified by numeral 184, are in fluid communication with passageway 182 and extend laterally through post 176. A dual compartment syringe 190 houses two components of a composite material curable upon mixing of the two components. The two components are simultaneously evacuated from the syringe and discharged through a tube or cannula 192 through opening 194 into passageway 182. Upon such injection of the composite material, it will flow through passageway 182 for discharge through each of lateral passageways 184 into the space between post 176 and passageway 174. Furthermore, the composite material will flow into each of annular grooves 178, 180. Upon curing, the composite material will affirmatively fix third variant implant 170 within bone or tooth 172. An abutment may be formed about stem 146 as described above with respect to FIGS. 14 and 15.

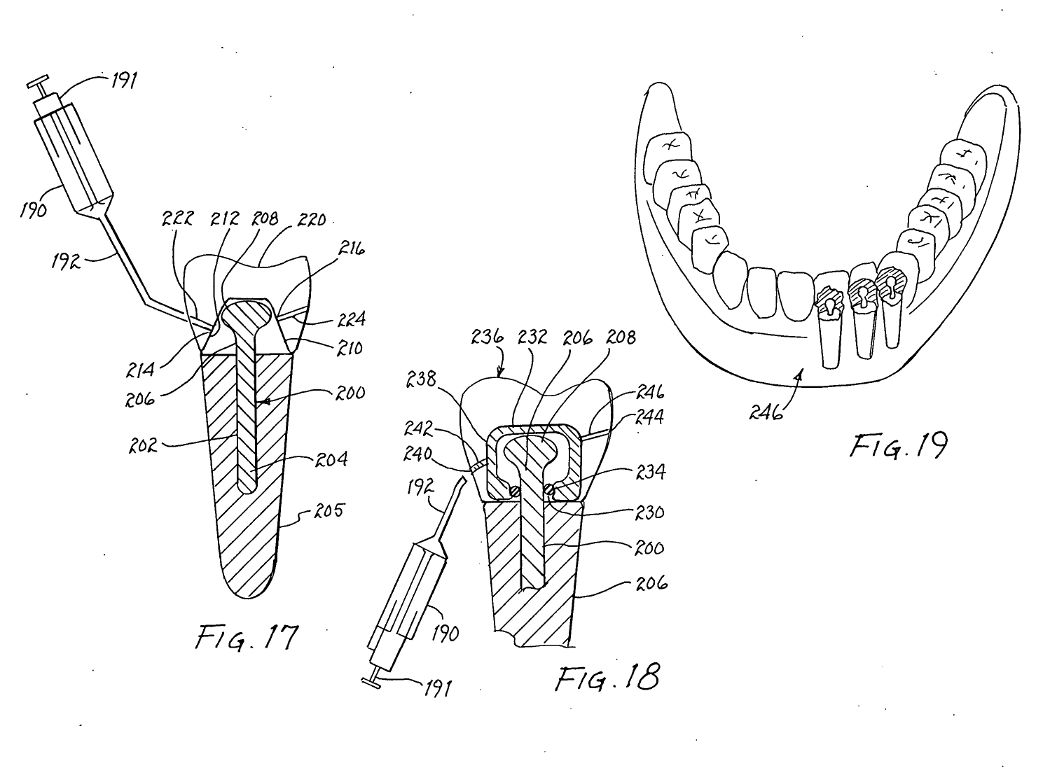

Alternatively, a crown or other restoration may be placed upon implant 170 with a cavity therein receiving post 146. The crown or restoration would have a passageway drilled therein to accommodate passage therethrough of a cannula connected to a syringe of composite material. The cannula would be inserted into passageway 182 of the implant. Upon actuating the syringe, the composite material would flow into passageway 182 and into the space between post 176 and passageway 174 and fill this space. Thereafter, the composite material would flow upwardly into the space within the cavity of the crown or the restoration and stem 146. A vent formed in the crown or restoration accommodates venting of the air. When the composite material flows out of the vent, the dentist would be assured that the implant would become fixed within the tooth or bone and that the crown or restoration would become secured to the stem of the implant. The passageway and vent formed in the crown or the restoration are illustrated in FIG. 17.

FIG. 17 illustrates a fourth variant implant 200. This implant includes a post 202 cemented or otherwise secured within a pre-drilled passageway 204 formed in bone or tooth 205. Stem 206 of the fourth variant implant extends above the bone or tooth and is terminated by a bulbous end 208. A crown 220 is formed with an interior cavity 210. The cavity is filled with a two part composite material housed within a syringe 190. As plunger 191 is depressed, the two parts of the composite material will mix upon ejection from the syringe and be conveyed through cannula 192 into passageway 222 and inlet port 214. Venting may be accomplished through a passageway 224 drilled in the crown. In operation, upon depressing plunger 191, the mixed composite material will flow through cannula 192 and passageway 222 in crown 220 into the cavity 210 of crown 220. After fill of cavity 210, excess composite material will be discharged through vent 224. Upon withdrawal of cannula 192 and curing of the composite material, a dentist would grind and polish the inlet to passageway 222 and the outlet of vent 224 to remove any residual external composite material.

The procedure illustrated in FIG. 17 and described above obviates the existing procedures described above for attaching a crown or restoration. That is, the patient will suffer minimal trauma and the gum tissue is unlikely to be injured. Moreover, the step of attaching the crown or restoration is essentially a one step process.

FIG. 18 illustrates a fourth variant implant 200, like that described with respect to FIG. 17. Accordingly, common reference numerals will be used. An O-ring 230 is lodged about stem 206 beneath bulbous end 208. A metal housing 232 fits over the bulbous end and into gripping engagement with O-ring 230 through an annular groove 234. A crown or other restoration 236 includes a cavity 238 for receiving metal housing 232 in a loose fit to provide space therebetween. The crown or other restoration is fixedly attached to the metal housing by a curable two part composite material like the type described above. A syringe 190 includes the two parts of the composite material. Upon depressing plunger 191, the two parts will mix to form the composite material which is conveyed through a cannula 192. The cannula is in fluid communication with an inlet port 240 connecting with a passageway 242 into cavity 238. Any excess composite material is vented through outlet 244 connected to passageway 246 extending into cavity 238. Upon curing of the composite material injected into cavity 238 about metal housing 232, the crown or other restoration forming a part of denture 246 will become fixedly attached to the metal housing. As illustrated in FIG. 19, the configuration described with respect to FIG. 18 is particularly useful for use in conjunction with dentures. That is, the denture may be removably held in place by the housing engaging the implant. More importantly, this process is a relatively quick essentially one step procedure for mating a denture, whether full or partial, with one or more implants. Thereafter, the denture, whether partial or full, is detachably attachable to the supporting implants.

I claim:

1. A dental implant comprising in combination:
a) a post for threaded engagement with bone, said post including a spiral thread;
b) a stem extending from said post, said stem being adapted for engagement by a conventional dental hand tool to rotate said implant into threaded engagement with the bone; and
c) a passageway extending longitudinally through said stem in fluid communication with a least one port disposed proximate the post.

2. The dental implant as set forth in claim 1 including a six faceted nut disposed about said stem proximate said post for engagement with a conventional dental hand tool.

3. The dental implant as set forth in claim 1 including a flat disposed on said stem for engagement by a conventional dental hand piece.

4. The dental implant as set forth in claim 3 including a six sided nut disposed about said stem proximate said post for engagement with a conventional dental hand tool.

5. The dental implant as set forth in claim 2 wherein at least one of said ports is disposed in a facet of said nut.

6. The dental implant as set forth in claim 1 wherein said stem includes a plurality of annular bands for positionally locking an abutment to be formed about said stem.

7. The dental implant as set forth in claim 6 wherein the diameter of said stem adjacent said bands is adapted for severing an upper section of said stem.

8. The dental implant as set forth in claim 1 wherein said post includes at least one detachable threaded tip for reducing the length of said post prior to insertion of said post into bone.

9. The dental implant as set forth in claim 8 wherein said post includes a pair of longitudinally aligned detachable threaded tips for selectively reducing the length of said post prior to insertion of said post into bone.

10. The dental implant as set forth in claim 1 wherein said stem includes a plurality of barbs spaced apart from one another along said stem to positionally lock an abutment to be formed about said stem.

11. The dental implant as set forth in claim 10 wherein said stem is of reduced diameter intermediate said barbs to facilitate cutting said stem to a length commensurate with the abutment to be formed thereon.

12. The dental implant as set forth in claim 1 wherein said post includes a lip at the upper end for a snap fit attachment with a mold defining the shape upon curing of composite material deposited therein to be shaped into an abutment.

13. The dental implant as set forth in claim 1 including a mold for defining the shape upon curing of composite material to be deposited therein and to be shaped into an abutment and a lip disposed about said post for a snap fit attachment with said mold.

14. The dental implant as set forth in claim 13 wherein said mold is in the shape of an open ended truncated cone having first and second circular openings.

15. The dental implant as set forth in claim 14 wherein said first opening is of smaller diameter than said second opening and wherein said first opening is engageable with said lip.

16. The dental implant as set forth in claim 15 wherein said cone includes a longitudinal axis and the plane of said first opening is not orthogonal to the longitudinal axis.

17. The dental implant as set forth in claim 13 wherein said mold is in the shape of a hollow cylinder.

18. The dental implant as set forth in claim 17 including a score line disposed in said cylinder to facilitate removal of said cylinder from about an abutment to be formed within said cylinder.

19. The dental implant as set forth in claim 17 including a manually accessible tab extending from said cylinder for aiding in positioning said cylinder upon said post.

20. The dental implant as set forth in claim 1 wherein said spiral thread extends for less than the fill length of said post and wherein said post includes a radially expanding section intermediate said spiral thread and said stem.

21. The dental implant as set forth in claim 20 wherein said expanding section comprises an inverted cone.

22. The dental implant as set forth in claim 20 wherein said expanding section includes a geometric taper.

23. A method for attaching a dental restoration to a dental implant, which dental implant includes a post for insertion into a selection one of a bone or a tooth, a stem extending from the post and including a bulbous end, a housing for receiving the stem and means for detachably attaching housing with the bulbous end, said method comprising the step of:
a) placing the dental restoration over the dental implant to locate the housing within a cavity in the dental restoration;
b) injecting composite material through a passageway in the dental restoration into the space between the housing and the cavity; and
c) venting the space to permit the composite material to fill the space.

24. The method as set forth in claim 23 wherein said step of venting comprises the step of venting through a further passageway in the dental restoration.

25. A method for mounting a dental implant, said method comprising the steps of:
a) threadedly engaging a post of the dental implant with a selected one of a bone or a tooth;
b) attaching a mold to the dental implant to envelope at least a part of a stem extending from the post;
c) injecting a curable material into a passageway extending through the stem;
d) discharging the material through at least one port in fluid communication with the passageway to at least partially fill the mold;
e) removing the mold upon curing of the material; and
f) shaping the cured material to form an abutment for the dental prosthetic.

26. The dental implant as set forth in claim 25 including the step of rotating the implant with a dental hand piece in engagement with the stem.

27. The dental implant as set forth in claim 25 including the step of rotating the implant with a dental ratchet.

28. The dental implant as set forth in claim 25 wherein the post includes at least one severable tip and including the step of severing the tip from the post prior to exercise of said step of engaging;

29. The dental implant as set forth in claim 25 wherein the post includes at least two longitudinally aligned severable tips and including the step of severing at least one of the tips prior to exercise of said step of engaging.

30. The dental implant as set forth in claim 25 including the step of severing a length of the stem.

31. The dental implant as set forth in claim 25 wherein said step of attaching includes the step of skewing the mold relative to the stem.

32. A method for attaching a dental prosthetic, said method comprising the steps of:
a) engaging a post of a dental implant with a selected one of a bone or a tooth to extend a stem of the dental implant from the bone or tooth;
b) placing the dental prosthetic over the stem to locate the stem within a cavity of the dental prosthetic;
c) injecting a curable material into the cavity to bond the stem with the dental prosthetic; and
d) venting the cavity during exercise of said step of injecting to essentially fill the cavity with the material.

33. The method as set forth in claim 32 wherein the dental prosthetic includes an inlet port for accommodating said step of injecting and an outlet port for accommodating said step of discharging and including the step of polishing the material present at the inlet and outlet ports on completion of said step of venting.

34. A dental implant comprising in combination:
a) means for engaging a post of said implant with bone;
b) means for rotating a stem of said implant to secure said implant in the bone, said stem including a base adjacent said post;
c) means for injecting a curable material through said stem for discharge at the base of said stem; and
d) means for forming an abutment about said stem to support a dental prosthetic.

35. The dental implant as set forth in claim 34 wherein said forming means comprises a mold detachably attachable to said dental implant.

36. The dental implant as set forth in claim 34 wherein a restoration to be attached to said dental implant includes a cavity for receiving said stem and wherein said injecting means includes a passageway in said dental implant extending into the cavity.

37. A dental implant comprising in combination:
a) means for threadedly engaging a post of said dental implant with a selected one of a bone or a tooth;
b) means for detachably attaching a mold to said dental implant to envelope at least a part of a stem extending from the post;
c) means extending through said stem for receiving a curable material; and
d) means for discharging the material through at least one port in fluid communication with said extending means to permit at least partial fill of said mold attached to said dental implant.

38. A dental implant as set forth in claim 37 wherein said detachably attaching means comprises a snap fit.

39. A dental implant for supporting a dental restoration, said dental implant comprising in combination:
a) a threaded post for engaging bone;
b) a stem extending from said post;
c) an element disposed on said stem for engagement by a tool to rotate said dental implant; and
d) a passageway extending through said stem and terminating in at least one port for directing a material into the space between said stem and a dental restoration to be mounted upon said stem.

40. A dental implant for supporting a dental restoration, said dental implant comprising in combination:
a) a post for engaging bone;
b) a stem extending from said post;
c) an element disposed on said stem for engagement by a tool to rotate said dental implant; and
d) a passageway extending through said stem and into said post and terminating in at least one port for directing a material into the space between said post and the bone.

41. A method for attaching a dental prosthetic to a dental implant having a stem extending from bone or tooth, said method comprising the steps of:
a) placing the dental prosthetic over the stem to locate the stem within a cavity of the dental prosthetic;
b) injecting a curable material through a passageway in the dental prosthetic into the cavity to bond the stem with the dental prosthetic; and
c) venting the cavity during exercise of said step of injecting to essentially fill the cavity with the material.
